(19) United States
(12) Patent Application Publication
(10) Pub. No.: US 2024/0421501 A1
(43) Pub. Date: Dec. 19, 2024

(54) RADIOFREQUENCY MODULE COMPRISING AN ARRAY OF ISOPHASIC WAVEGUIDES

(71) Applicant: SWISSto12 SA, Renens (VD) (CH)

(72) Inventors: Esteban Menargues Gomez, Préverenges (CH); Santiago Capdevila Cascante, Renens (CH); Emile de Rijk, Grand-Saconnex (CH); Mathieu Billod, Présilly (FR); Tomislav Debogovic, Chexbres (CH)

(21) Appl. No.: 18/704,661

(22) PCT Filed: Oct. 26, 2022
(86) PCT No.: PCT/IB2022/060264

§ 371 Date: Apr. 25, 2024

(30) Foreign Application Priority Data
Oct. 27, 2021 (FR) FR2111441

(51) Int. Cl. H01Q 21/22; H01Q 21/00; H01Q 21/06

(52) U.S. Cl. CPC H01Q 21/22; H01Q 21/0087; H01Q 21/064

(57) ABSTRACT

A radiofrequency module includes a first layer having an array of radiant elements, each radiant element having a cross section supporting at least one wave propagation mode, a second layer forming an array of waveguides, each waveguide being connected to one radiant element of the first layer; one or more of the waveguides of the array of waveguides having at least one phase-adjustment element for eliminating or correcting the phase shift of the waveguides with respect to each other at a nominal waveguide frequency.

### TECHNICAL FIELD

The present invention relates to a radiofrequency module (RF) comprising an array of several non-identical waveguides. The waveguides may be of different lengths. The radiofrequency module and/or the waveguides that it contains can be used to deliver an isophase signal despite the differences between the waveguides. The present invention aims in particular to control the phase shift between the waveguides or to minimize or eliminate it.

### PRIOR ART

The use of waveguides of the same length in waveguide arrays in order to keep the phase the same over a wide frequency band is known. For example, US2013154764 discloses that the effective path length of two waveguides may be equal.

US2012112963 discloses a Butler matrix having a plurality of hybrids and waveguides so that the output of a Butler matrix has the same amplitude and a constant phase difference with respect to an input signal. The transmission lines connecting the hybrids need to be designed to have the same transmission length, or the amplitude and phase need to be adjusted according to the resultant change. Moreover, a curved waveguide can increase the complexity of the paths.

JP2003185858 discloses a wavelength demultiplexer that has an input channel optical waveguide 1, a plurality of output channel optical waveguides 5 and an array waveguide 8 interposed between the input waveguide 1 and the output waveguide 5.

WO2020194270 describes a radiofrequency module comprising waveguides provided with ridges that increase the single-mode bandwidth.

Document US2021218151 describes assemblies of waveguides of different lengths, whose cross section is designed to correct the resulting phase shift.

DRA antenna arrays, which combine several phase-shifted radiating elements (elementary antennas) in order to improve gain and directivity, are also known. The signals received on the different radiating elements, or transmitted by these elements, are amplified with variable gains and phase shifted with respect to each other in order to control the shape of the reception and transmission lobes of the array.

At high frequencies, for example microwave frequencies, each of the different radiating elements is connected to a waveguide which transmits the received signal to the radiofrequency electronic modules, or which supplies this radiating element with a radiofrequency signal to be transmitted. The signals transmitted or received by each radiating element may also be separated according to their polarization, using a polarizer.

The assembly formed by the array of radiating elements (elementary antennas), the associated waveguides, any filters that are used, and the polarizers is referred to in the present text as a passive radiofrequency module. The waveguides and the associated polarizers are referred to as a feed network. The assembly is intended to form the passive part of a direct radiating array (DRA).

Arrays of radiating elements for high frequencies, in particular microwave frequencies, are difficult to design. In particular, it is often desirable to place the different radiating elements of the array as close together as possible, in order to reduce the amplitude of the transmission or reception side lobes in directions other than the transmission or reception direction which is to be given priority. However, this reduction of the pitch between the different radiating elements of the array is incompatible with the minimum size required by the polarizers and with the space requirement of the electronic amplification and phase-shifting circuits upstream of the polarizers. The size of the polarizers and the electronic system usually determines the minimum pitch between the different radiating elements of an array. The resulting wide pitch gives rise to unwanted transmission or reception side lobes. However, other radiofrequency modules require the radiating elements to be spaced further apart, in order to provide them with a transmission cone, for example. For example, WO2019229515 describes an assembly of non-straight waveguides of various lengths and shapes, enabling the pitch between the radiating elements to be reduced or increased, thus modulating the side lobes. The phase shift resulting from their different lengths is compensated for by adapting the cross section of the different waveguides.

The result is a limitation in the reduction in the space requirement and/or the weight of the radiofrequency module, which is detrimental to applications that are sensitive to these weight and space requirement parameters, such as those relating to the aerospace and aeronautical industries.

Waveguides therefore need to be improved in order to control the phase shift inherent in their differences, in particular their different lengths, without needing to modify their overall space requirement, and in particular the shape and dimensions of their cross section.

### BRIEF SUMMARY OF THE INVENTION

One aim of the present invention is therefore to propose a passive radiofrequency module intended to form the passive part of a direct radiating array or DRA, which is free from or minimizes the limitations of known devices.

These aims are, in particular, achieved by means of a radiofrequency module as described in the independent claims and detailed by the dependent claims.

This radiofrequency module comprises, in particular, a first layer comprising an array of radiating elements, each radiating element having a cross section supporting at least one wave propagation mode.

It may further comprise a second layer forming an array of waveguides.

It may further comprise a fourth layer forming an array of ports.

The second layer may be interposed between the first layer and the fourth layer.

Each waveguide may be intended to transmit a radiofrequency signal in one direction or another between a port of the fourth layer and a radiating element.

The surface area of the first layer may be different from the surface area of the fourth layer.

The waveguides may have different lengths and shapes, but preferably have the same cross section. One or more of the waveguides comprise at least one phase-adjustment element.

The waveguides therefore have several cumulative functions: they enable signals to be transmitted between the ports of the fourth layer and the radiating elements of the first layer, and allow the pitch of the radiating elements and the pitch of the ports of the fourth layer to be selected independently. They also help correct or eliminate any phase shifts inherent to the structure of the module. Moreover, they allow a more compact arrangement, which could be impossible or more difficult using existing means.

This arrangement also makes it possible to reduce the pitch between the radiating elements of the first layer, in order to reduce the amplitude of unwanted side lobes (“grating lobes”).

To this end, the pitch (p1) between two radiating elements of the first layer is preferably less than λ\2, λ being the wavelength at the maximum operating frequency.

The arrangement of the waveguides converging from the fourth layer towards the radiating elements also allows the ports of the fourth layer to be spaced apart. The wide pitch between the ports makes it possible, for example, to arrange the electronic amplification and phase-shifting circuit supplying each port in the immediate vicinity of each port, reducing the constraints on the dimensions of this circuit. This wide pitch also makes it possible to arrange polarizers of sufficient size near to each port, if necessary, in order to effectively separate the signals according to their polarization.

In another embodiment, the surface area of the first layer is larger than the surface area of the fourth layer. The waveguides then move away from each other between the fourth layer and the first layer. This embodiment makes it possible to use relatively large radiating elements, but without requiring a larger layer of ports.

The arrangement of the radiating elements of the first layer may be different from the arrangement of the ports of the fourth layer. For example, the radiating elements of the first layer may be arranged in a rectangular matrix MxN whereas the ports of the fourth layer are arranged in a rectangular matrix KxL, M being different from K and N being different from L. This different arrangement may also involve different shapes, for example a rectangular arrangement on one of the layers and a circular, oval, cross-shaped, hollow rectangle, polygonal, etc. arrangement on the other layer.

The radiofrequency module may comprise a third layer interposed between the second layer and the fourth layer.

The elements of the third layer can transform the signal.

The third layer may also comprise an array of elements providing cross-section adaptation between the cross section of the output of the ports of the fourth layer and the differently shaped cross section of the waveguides. A third layer of this type may in particular be provided when only the ports or only the waveguides are ridged.

The third layer interposed between the second layer and the fourth layer may also comprise an array of polarizers as elements.

In one variant, the radiofrequency module may comprise external polarizers just after the elements radiating into the air.

The third layer interposed between the second layer and the fourth layer may comprise a filter.

Each radiating element of the first layer may be provided with at least one ridge parallel to the signal propagation direction.

The radiating elements of the first layer may also not comprise ridges and be constituted by open waveguides or square, circular, pyramid-shaped or spline-shaped horns.

The radiating elements may have a square, rectangular, or preferably hexagonal, circular or oval external cross section.

The pitch (p1) between two radiating elements may vary within the module.

Each waveguide of the second layer is preferably designed to transmit either only a fundamental mode or a fundamental mode and a single degenerate mode.

The length of the different waveguides of the second layer may be variable. However, the waveguides are rendered isophasic at the wavelength in question, in particular by virtue of the presence of at least one phase-adjustment element.

The channel of different waveguides may be non-straight. The waveguides of the second layer may be curved.

The curvature of the different waveguides of the second layer may be variable. For example, the waveguides at the periphery may be more curved than the waveguides at the center.

The ports of the fourth layer may constitute the inputs of a polarizer.

A first end of all of the waveguides may lie in a first plane, whereas a second end of all of the waveguides lies in a second plane.

The module is advantageously a module produced by additive manufacturing.

Additive manufacturing makes it possible, in particular, to produce waveguides of complex shapes, in particular curved waveguides converging in a funnel shape between the layer of radiating elements and the layer of polarizers.

“Additive manufacturing” should be understood to mean any method for manufacturing parts by adding material, according to computer data stored on a computer medium and defining a model of the part. In addition to stereolithography and selective laser melting, the expression also refers to other manufacturing methods involving curing or coagulating liquid or powder, in particular, including but not limited to methods based on binder jetting, DED (direct energy deposition), EBFF (electron beam freeform fabrication), FDM (fused deposition modeling), PFF (plastic freeforming), aerosols, BPM (ballistic particle manufacturing), powder bed fusion, SLS (selective laser sintering), ALM (additive layer manufacturing), PolyJet, EBM (electron beam melting), photopolymerization, etc. Manufacturing by stereolithography or selective laser melting is preferred, however, as it produces parts with relatively clean, smooth surfaces.

The module is preferably designed as a single piece.

Manufacturing the module as a single piece helps reduce costs by eliminating the need for assembly. It also helps ensure that the different components are accurately positioned in relation to each other.

The invention also relates to a module comprising the above elements and an electronic circuit with amplifiers and/or phase shifters connected to each port. The invention further relates to any object comprising such a module, in particular a communication object. Such an object may be specifically dedicated to the aerospace and aeronautical field. It may, for example, be a communication satellite. The invention further relates to a method for designing and producing the module forming the subject matter of the present description.

### BRIEF DESCRIPTION OF THE FIGURES

Implementation examples of the invention are indicated in the description, illustrated by the following appended figures:

FIG. 1 Schematic side view of the different layers of a module according to the invention.

FIG. 2 Two embodiments of the third layer, in which each element of this layer comprises either one or two inputs on the fourth layer side.

FIG. 3A, FIG. 3B and FIG. 3C Schematic representations of the second and third layers of an example of a module according to the prior art.

FIG. 4 Schematic representation of a waveguide according to an embodiment of the present description.

FIG. 5A and FIG. 5B Schematic representation of a waveguide according to another embodiment of the present description.

FIG. 6A, FIG. 6B and FIG. 6C Schematic representation of a waveguide according to other embodiments of the present description.

FIG. 7A and FIG. 7B Schematic representation of a waveguide according to other embodiments of the present description.

### EXAMPLE(S) OF EMBODIMENTS OF THE INVENTION

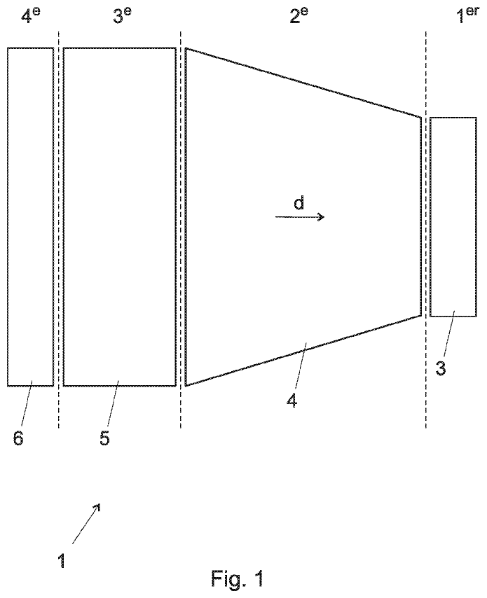

FIG. 1 shows a passive radiofrequency module 1 according to a first embodiment of the invention, intended to form the passive part of a direct radiating array or DRA.

The radiofrequency module 1 of this example comprises four layers 3, 4, 5, 6.

Of these layers, the first layer 3 comprises a two-dimensional array of N radiating elements 30 (antennas) for transmitting electromagnetic signals into the ether, or for receiving the signals that are received.

The second layer 4 comprises an array of waveguides 40.

The third layer 5 is optional; it may also be incorporated into the second layer 4. When it is present, the third layer 5 comprises an array of elements 50, for example polarizers or cross-section adapters.

The fourth layer 6 comprises a two-dimensional array, for example a rectangular matrix, with N ports 60 of waveguide 40. Each port 60 forms an interface with an active element of the DRA such as an amplifier and/or a phase shifter, being part of a beamforming (also known as spatial filtering or channel forming) array. A port therefore makes it possible to connect a waveguide to an electronic circuit, in order to inject a signal into the waveguides or conversely to receive the electromagnetic signals in the waveguides.

It is also possible to use 2N ports 60A, 60B, if a linearly or circularly polarized antenna is used.

Instead of incorporating the polarizers into the third layer 5, it is also possible to use a layer of polarizers between the first layer 3 with the radiating elements and the second layer 4 with the waveguides, or to incorporate polarizers into the radiating elements. This solution has the advantage of bringing the polarizers closer to the radiating elements, and of avoiding the complexity of transmitting a signal with several polarities in each waveguide.

This module 1 is intended to be used in a multi-beam environment. The radiating elements 30 are preferably close to each other so that the pitch p1 between two adjacent radiating elements is smaller than the wavelength at the nominal frequency at which the module 1 is intended to be used. This reduces the amplitude of the transmission and reception side lobes.

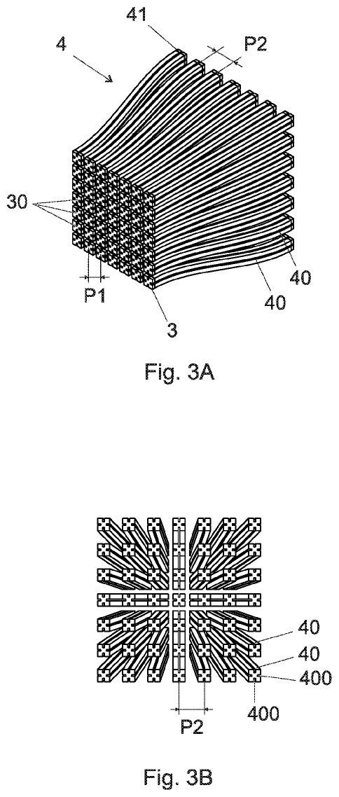

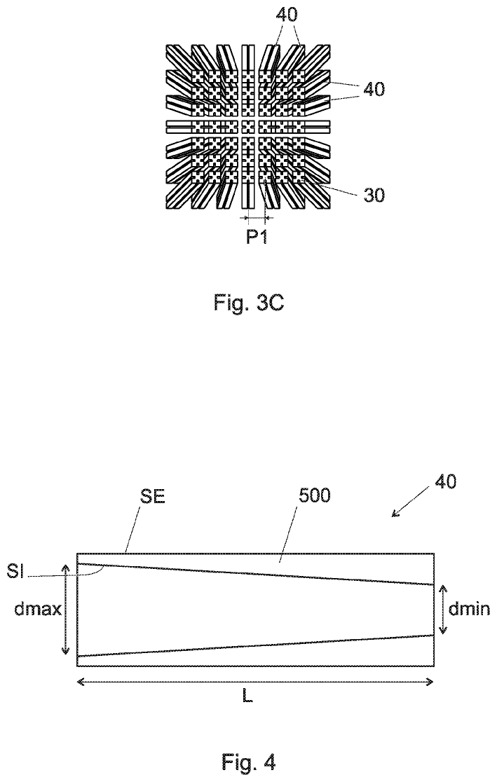

FIGS. 3A to 3C show different views of an example of a module according to the prior art, without the third and fourth layers. In this example, the waveguides 40 and the radiating elements 30 have a square cross section provided with four ridges arranged symmetrically on the inner walls. The waveguides converge towards the first layer 3. In the embodiments shown in FIGS. 1 and 3A to 3C, the radiating elements 30 are constituted by waveguides whose inner cavity is provided with ridges or crests 300, for example two, three or four crests 300, for example set apart at equal angular distances.

The present invention is characterized by the presence of one or more phase-adjustment elements 500, arranged protruding from the inner surface of the waveguides 40. The phase-adjustment elements 500 may be arranged as a replacement for or in addition to the ridges or crests 300 known from the prior art. In this case, the phase-adjustment elements 500 are used to eliminate the phase difference inherent in the variations in length and/or geometry of the waveguides 40 of a given assembly. They also make it possible to limit or eliminate variations in the shape and dimensions of the waveguides 40 in a given assembly.

Eliminating the phase differences by means of phase-adjustment elements 500 makes it possible to produce a signal with no phase shift. However, the phase-adjustment elements 500 can make it possible to control the phase shift, for example in order to better control the side lobes. Therefore, a specific phase shift may be induced by virtue of the phase-adjustment elements 500, limited, for example, to certain waveguides 40, depending on their position in the waveguide matrix or other factors.

Different phase shifts are obtained in different waveguides of a given radiofrequency module by using phase-adjustment elements that differ from one waveguide to the next. For example, the cross section of these elements, their length, height and/or how many of them there are, may vary from one waveguide to the next in such a way as to produce different phase shifts and, for example, to compensate for length differences between different waveguides.

The waveguides 40 may thus have a transverse section with a constant or practically constant shape and size. The shape of the transverse section essentially refers to the outer contour of a given waveguide 40. According to one aspect, it excludes the shape and the cross section of the inner surface of the waveguide. According to another aspect, it excludes any geometry or internal element of the waveguide other than the inner contours whose shape corresponds to the outer contours. The shape of the transverse section refers not only to the geometric shape of the transverse section but also to its dimensions. The shape of the cross section of a given waveguide 40 is preferably constant or practically constant over the entire length of the waveguide 40. The shape of the transverse section of all of the waveguides 40 of a given assembly is preferably identical, even if the waveguides 40 are of different lengths.

The length variations between the waveguides 40 are likely to generate phase shifts that need to be rectified or compensated for, at least partially. Other parameters such as the variation in the longitudinal shapes of the waveguides, even if they are the same length, may produce phase shifts. In particular, variations in the radii of curvature, or in the number of curves of the waveguides 40, may produce such phase shifts. Other parameters such as possible variations in roughness or combinations of materials used to manufacture the waveguides are also likely to influence the phase shift. Inner structures arranged in waveguides, such as ridges or crests or peaks, can also produce a phase shift that needs to be eliminated or compensated for. It is understood that the present invention applies to any assembly of waveguides 40 producing an unwanted phase shift in the signal, whether due to length variations or other structural or compositional parameters of the waveguides.

The phase-adjustment elements 500 according to the present description make it possible to eliminate the phase shift, or in any case to control it. This means that the waveguides of a given assembly, some or all of which comprise one or more of the phase-adjustment elements 500, are isophasic. The phase-adjustment elements 500 alternatively make it possible to control the phase shifts. This means, in particular, that the differences in phase shift between waveguides, which are inherent to the structure of the waveguides of the module, can be reduced or made similar or even identical. This also means that phase shifts can be produced in a controlled manner. This may be required, for example, in order to limit or eliminate side lobes or interference between radiating elements. The phase-adjustment elements 500 can be used to correct phase shifts that are initially expected as a result of the waveguide structure, but that ultimately diverge from the expected values. In this case, the phase-adjustment elements help rectify any structural or manufacturing faults in order to obtain the required phase-shift value for each waveguide in the module.

A phase-adjustment element 500 may, for example, be in the form of a variation of the inner diameter of the waveguide 40. FIG. 4 shows such an example of a waveguide 40, having an inner surface SI forming a maximum diameter dmax and a minimum diameter dmin, and an outer surface SE with a cross section and shape that remain constant along its length L. Although the waveguide 40 shown is straight, it may be non-straight. It may also have transverse sections in any of the shapes already disclosed in the present description. For example, the cross section of the waveguide may be hexagonal or polygonal, square, rectangular, round, or oval, or of any other suitable geometry. The phase-adjustment element 500 may gradually reduce the inner diameter of a waveguide 40 between a maximum diameter dmax and a minimum diameter dmin, over its entire length L or only along part of its length L. In the latter scenario, it is a local reduction of the inner diameter that can, for example, compensate for the effects of curvature in the waveguide. Such an arrangement may be localized in one or more central portions of the waveguide 40 or indeed at one or more of its ends. The values of the maximum diameter dmax and minimal diameter dmin can be determined as a function of the length L of the waveguide 40 or its difference in length from the adjacent waveguides. Alternatively, or additionally, the slope of the variation in diameter between the values dmax and dmin, or indeed the length of the adjustment element 500, may be determined as a function of the length L of the waveguide 40 or its difference in length from the adjacent waveguides.

For example, the value of the maximum diameter dmax may correspond to the diameter of the inner surface SI, or indeed to a fraction of the order of 70% or 80% or approximately 90%, or approximately 95% of the diameter of the inner surface SI.

The minimum diameter dmin may correspond to a value of the order of 60% or approximately 50%, or indeed 40% of the diameter of the inner surface SI.

If several phase-adjustment elements 500 are arranged in a waveguide, they may each have their own maximum diameter dmax value and minimum diameter dmin value.

The diameter should be understood here to mean the dimension of the inner space of the waveguide 40, irrespective of the geometry of its cross section. It therefore applies equally to both round or oval cross-section shapes and polygonal shapes.

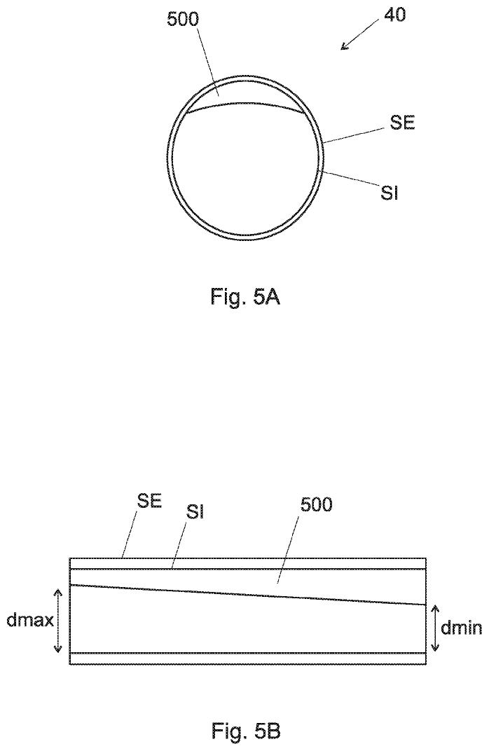

On a transverse section of the waveguide 40 comprising a phase-adjustment element 500, the phase-adjustment element may cover the entire inner surface SI. Alternatively, the phase-adjustment element 500 may be arranged over part of the transverse section of the waveguide 40. FIGS. 5A and 5B show an example of a waveguide 40 with a round cross section comprising a phase-adjustment element 500 covering part of the cross section of the waveguide 40. FIG. 5A shows the corresponding transverse section and FIG. 5B a longitudinal section.

The proportion of the transverse section comprising a phase-adjustment element 500 may, for example, be of the order of 10% or more, or of the order of 20% or more or of the order of 30% or more of the inner surface SI corresponding to this transverse section. It may be as much as 100% of the inner surface SI for a given transverse section. From one end to the other of the phase-adjustment element 500, the proportion of the inner surface SI occupied by the phase-adjustment element 500 may vary, for example, from approximately 10% to approximately 90% or from 20% to approximately 80%, or from 30% to approximately 70% of the inner surface SI. In other words, the surface area occupied by a phase-adjustment element 500 varies from a minimum surface area Smin value to a maximum surface area Smax value along the waveguide 40.

The thickness of a phase-adjustment element 500 over a given transverse section of a waveguide may not be identical over the entire surface area occupied by the phase-adjustment element.

When a phase-adjustment element 500 only covers a fraction of the surface area of a transverse section, it may be oriented parallel to the longitudinal axis of the waveguide 40. Alternatively, a phase-adjustment element 500 may deviate from the longitudinal axis of the waveguide 40 and adopt a helical configuration along the inner surface SI of the waveguide 40.

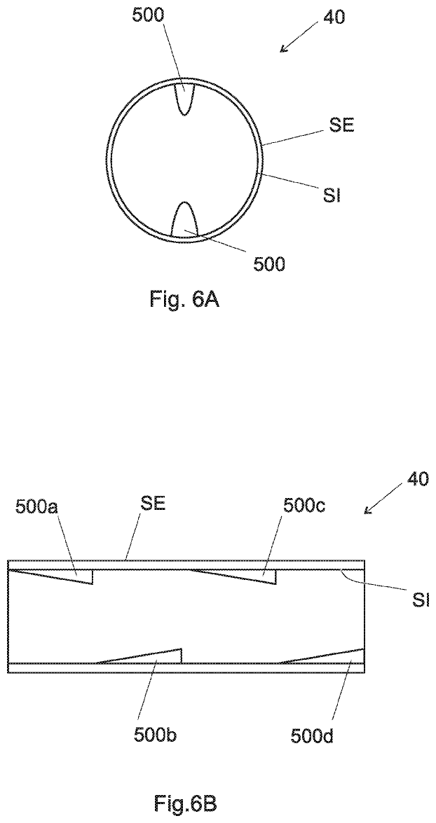

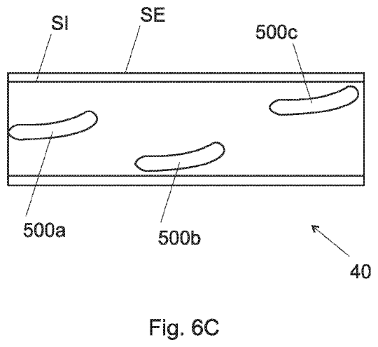

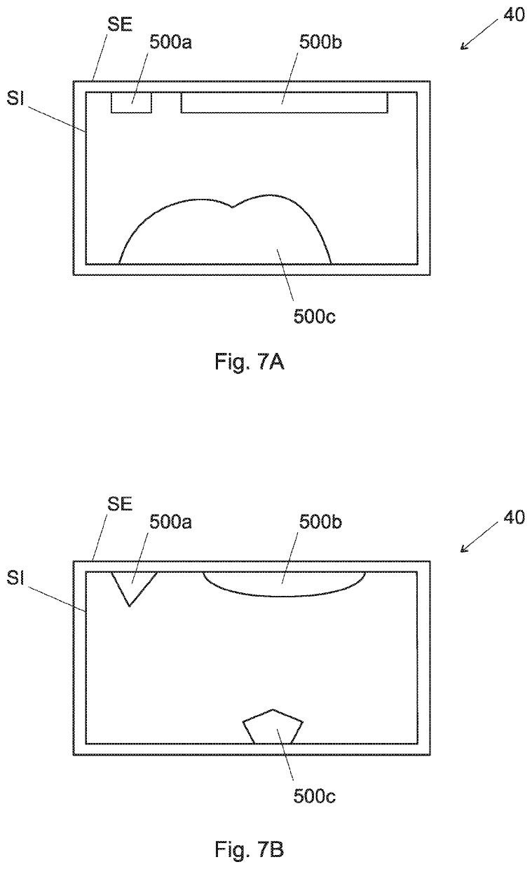

The surface of the phase-adjustment element 500 oriented towards the inside of the waveguide 40 may be rounded and concave, as shown in FIG. 5A. Alternatively, it may be rounded and convex, as shown in FIG. 6A. Other shapes may be determined, in particular angular shapes such as triangular or rectangular shapes, as shown in FIGS. 7A and 7B.

If several phase-adjustment elements 500 are arranged in a waveguide, they may be arranged on the same sections of the waveguide 40, i.e., opposite each other.

FIG. 6A shows a cross-section of a waveguide 40 comprising two phase-adjustment elements 500 arranged opposite each other. FIG. 6B shows a longitudinal section of a waveguide 40 comprising several adjustment elements 500a, 500b, 500c, 500d offset from each other along the waveguide. FIG. 6C shows another cross-sectional view where the phase-adjustment elements 500a, 500b, 500c are arranged in an offset manner and oriented along an axis different from the longitudinal axis of the waveguide 40. In particular, they form an angle with the longitudinal axis of the order of 10° to approximately 40°.

FIGS. 7A and 7B show other examples of waveguides 40 with a rectangular cross section and comprising several differently shaped phase-adjustment elements 500a, 500b, 500c of different shapes. It should be understood that each of the shapes that is shown may be chosen separately from the others, and that a given shape may be replicated in a given waveguide 40. The shape of the cross section of a phase-adjustment element 500 may in particular be selected from a rounded concave shape, a rounded convex shape, a polygonal shape, or a combination of these shapes.

According to one embodiment, the phase-adjustment elements 500 discussed in the present description may be arranged in addition to other elements already present in the waveguide 40 and not involved in the elimination or the controlled modulation of the phase shift, such as grooves, crests or tips. This is particularly the case when these elements alone are unable to eliminate the phase shift of the signal as desired from one waveguide 40 to another. For example, radiating elements comprising ridges 300 allow dimensions smaller than the wavelength of the signal that is to be transmitted or received. In particular, the diameter of the waveguides may be smaller than the wavelength of the signal. However, such elements are not necessarily isophasic and require a phase shift correction. The phase-adjustment elements 500 therefore allow the small dimensions of the waveguides 40, which are made possible by the presence of ridges, to be maintained, while allowing the phase shift to be eliminated or controlled. Examples of waveguides comprising such longitudinal elements such as ridges or crests have also been given, which help increase the single-mode bandwidth of each waveguide device. WO2020194270 provides one of these examples. It may nevertheless remain necessary to eliminate or modulate the phase shift. This is made possible by the phase-adjustment elements of the present description. The structures added to the waveguides 40 for particular reasons can also cause a phase shift that needs to be corrected.

According to another embodiment, the phase-adjustment elements 500 are arranged in waveguides 40 that do not comprise any of the other elements mentioned above. According to one particular arrangement, they may be arranged to replace elements already present in the waveguide 40 and having functions other than those of modulating or eliminating the phase shift. In this case, the phase-adjustment elements 500 perform the function of the elements that they replace, while modulating or eliminating the phase shift. For example, the phase-adjustment elements 500 may be arranged in a waveguide 40 to replace one or more of the ridges 300 that it comprises. The adapted geometry of the phase-adjustment elements 500 therefore makes it possible to maintain small dimensions while controlling the phase shift.

Whether the phase-adjustment elements 500 are arranged as a replacement for or in addition to other elements already present in the waveguide 40, they make it possible in all cases to avoid or limit the variations in waveguide cross-section that are normally required to eliminate or correct the phase shift. The increased uniformity in the diameters of the waveguides helps make the device more compact.

According to one embodiment, the diameter and/or the surface area occupied by phase-adjustment elements 500 arranged as a replacement for or in addition to other elements that are not involved in correcting or modulating the phase shift are constant. In other words, the maximum diameter dmax and minimum diameter dmin values, or indeed the surface area occupied for a given cross section of the waveguide 40, are equal for a given phase-adjustment element 500.

The phase-adjustment elements 500 may be symmetrical and/or arranged in the waveguide 40 in a symmetrical or regular manner. Alternatively, the phase-adjustment elements 500 have no particular symmetry and may therefore be non-symmetrical. They may be arranged in the waveguide in an irregular manner, i.e., at non-identical intervals. In this case, they may be concentrated locally in places where the shape of the waveguides 40 varies, for example at or close to curves.

Within a waveguides 40 assembly, each of the waveguides 40 may have a specific influence on the phase shift of the signal in relation to the signal relating to the other waveguides 40 of the assembly. This specific influence may be the result of a difference in length or other factors. The phase-adjustment elements 500 are designed to correct the impact of the different waveguides on the phase shift of the signal in a specific manner. In other words, the number, shape, dimensions and arrangement of the phase-adjustment elements 500 may vary from one waveguide 40 to another.

Within a waveguide 40 assembly, some waveguides may be provided with no phase-adjustment elements 500 and other waveguides 40 may be provided with such phase-adjustment elements. Therefore, some or all of the waveguides of an assembly may comprise one or more identical or different phase-adjustment elements 500.

Within a waveguide 40 assembly, all of the waveguides preferably have the same transverse section, in terms of both shape and dimensions. As a result, their phase shift is not compensated for by a variation in the shape or dimensions of their cross section. A waveguide assembly may nevertheless comprise waveguides in which the shape and dimensions of their cross section differ from one to the next, without these cross-sectional differences allowing the desired elimination, modulation or correction in phase shift.

Within an assembly, the waveguides 40 may be separated from each other. Alternatively, they may be linked to each other in such a way as to maintain their relative positions. They may form a single-piece assembly. The link between the waveguides may be established, for example, by the first layer 3, the third layer 5 and/or the fourth layer 6. It is also possible to produce holding elements in the form of bridges between different waveguides. Alternatively, the waveguides may be in direct contact with each other along their entire length or over a portion of their length.

An array of radiating elements 30 in the first layer 3 comprises N radiating elements 30. The radiating elements 30 may be arranged in a matrix that is rectangular, square or of any other geometry suited to requirements. For example, the radiating elements may form lines having a number of radiating elements that varies across the lines, the general shape of the layer forming an octagon. The radiating elements 30 may be phase shifted on successive lines, the value of the phase shift possibly being less than the pitch p1 between two adjacent elements 30 on the same line. A first layer 3 of any polygonal or substantially circular shape can also be produced. The radiating elements 30 may also be arranged in a triangle, rectangle or diamond, with aligned or phase-shifted lines.

The phase and the amplitude of each radiating element of the first layer 3 help achieve a high level of isolation between the different beams. Radiating elements that are smaller than the wavelength reduce the impact of the side lobes in the covered region.

Any shape of radiating element supporting at least one propagation mode may be implemented, including rectangular, circular or rounded shapes, which may or may not be ridged.

The radiating elements 30 may be single- or dual-polarized. The polarization may be linear, inclined or circular.

The pitch p1 between two radiating elements 30 of the first layer 3 is preferably less than or equal to λ/2, λ being the wavelength at the maximum frequency for which the module is designed.

The radiating elements may include polarizers, which are not shown, for example at the junction with the second layer 4. In another embodiment that is not shown, polarizers are provided just after the free-air portion into which the transmitted signal is radiated. As disclosed below, polarizers may also be provided in the third layer 5.

The second layer 4 comprises N waveguides 40. Each waveguide 40 transmits a signal from a port 60 and/or an element of the third layer 5 to a corresponding radiating element 30 when transmitting, and vice versa when receiving. The waveguides 40 also perform a conversion between the arrangement of the elements 60 on the third layer 5 and fourth layer 6 and the different arrangement of the first layer 3 of radiating elements.

The waveguides 40 may be curved in order to make the transition between the surface area of the third or fourth layer 6 and the different surface area of the first layer 3 of radiating elements. The waveguides thus form a funnel-shaped volume.

The second layer 4 may help adapt the pitch between adjacent elements. In one embodiment, it may also be designed in such a way as to make a transition between the arrangement of the radiating elements 30 of the first layer 3 and a different arrangement of the ports 60 of the fourth layer 6. For example, the second layer 4 may make a transition between an array of elements or ports arranged in a rectangular matrix and an array of elements or ports arranged in a different matrix, or in a polygon, or in a circle.

At least some waveguides 40 may be curved. In particular, at least some waveguides are curved in two planes perpendicular to each other and parallel to the longitudinal axis of the module. These waveguides 40 are thus curved into an S shape in two planes orthogonal to each other and parallel to the main direction of transmission of the signal.

The connection plane between the waveguides 40 and the radiating elements 30, and the connection plane between the waveguides 40 and the elements 50, are preferably parallel to each other and perpendicular to the main direction of transmission of the signal.

The waveguides 40 at the periphery of the second layer 4 may be more curved than those close to the center, and longer. The waveguides 40 close to the center may be straight. The phase-adjustment elements 500 therefore differ between the peripheral and central waveguides 40.

The dimensions of the internal channel through the waveguides 40 and those of the input 41, as well as their shapes, are determined as a function of the operational frequency of the module, i.e., the frequency of the electromagnetic signal for which the module 1 is manufactured and for which a transmission mode that is stable and optionally has a minimum attenuation is obtained.

As disclosed above, the different waveguides 40 in the second layer 4 may have different lengths and curvatures, which influence their frequency response curve. These differences may be compensated for by the electronic system supplying each port 60 or processing the received signals. However, these differences are preferably at least partially compensated for by adapting one or more of the shape, number, dimensions and geometry of the phase-adjustment elements 500 of the present description.

According to one advantageous arrangement, the presence of the phase-adjustment elements eliminates the need for electronic elements dedicated to correcting the phase shift.

All the waveguides have the same shape and cross-sectional dimensions.

If the length of the different waveguides 40 of the second layer is identical, some waveguides may comprise one or more phase-adjustment elements 500 intended to locally control the phase shift of the signal. Such an arrangement makes it possible, for example, to influence the side lobes.

Alternatively, when the length of the different waveguides 40 differs from one waveguide to another, the phase-adjustment elements 500 described here help obtain an assembly of waveguides that are isophasic at the wavelength in question. The waveguides of such an assembly of isophasic waveguides each help to produce a signal that has no phase shift in relation to the signal of the other waveguides of the assembly despite differences in the length, curvature or shape of the waveguides. To this end, the different waveguides comprise one or more phase-adjustment elements designed to compensate for the variation in phase resulting from the different lengths or shapes of the different waveguides.

It is also possible to use waveguides that are of different lengths, and/or produce different phase shifts, despite being provided with the phase-adjustment elements described here, and to use or compensate for these phase shifts with the array of active electronic phase shifting circuits, in order to control the relative phase shift between radiating elements and, for example, to control beamforming.

Depending on the embodiment, the second layer 4 may also include other waveguide elements such as filters, polarization converters or phase adapters.

Each waveguide 40 may be intended to transmit a single-polarized or dual-polarized signal.

The third layer 5 is optional and comprises elements 50. In one embodiment, the elements 50 provide a transition between the transverse section of the ports 60 of the fourth layer 6 and the transverse section, which may be different, of the waveguides 40 of the second layer 4, generally corresponding to the transverse section of the radiating elements of the first layer 3. For example, the waveguides of the third layer 5 provide a transition between the square or rectangular cross section of the output of the ports 60 and the cross section of the waveguides 40 and radiating elements 30, which may be provided with ridges 300.

Depending on the embodiment, the elements 50 of the third layer 5 may also transform the signal, for example by means of other waveguide elements such as filters, polarization converters, polarizers, phase adapters, etc.

The transverse surface area of the third layer 5 is preferably equal to the transverse surface area of the fourth layer 6.

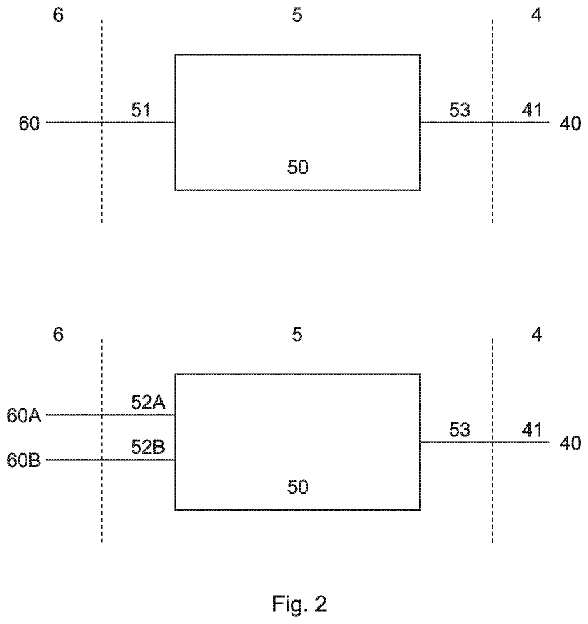

FIG. 2 shows an example of an element 50 of the third layer 5. Dans the embodiment at the top of the figure, this element 50 comprises an input 51 connected to a port 60 and an input 53 connected to the input 41 of a waveguide 40.

Dans the embodiment at the bottom of the figure, this element 50 comprises two inputs 52A, 52B, each being connected to a port 60A or 60B of the fourth layer, and an input 53 connected to the input 41 of a waveguide 40. In this embodiment, the element 60 preferably comprises a polarizer for combining or separating two polarities on the ports 60A, 60B, to/from a combined signal on the waveguide 40.

The phase-adjustment elements in the waveguide channel can filter the radiofrequency signal in the waveguide (comb filter). This filtering can be controlled in such a way as to attenuate unwanted frequency bands or propagation modes. Filtering may also be an unwanted consequence of the presence of the phase-adjustment elements in the waveguide channel. In this case, the phase-adjustment elements will be positioned and dimensioned in such a way as to attenuate only frequencies far from the nominal frequency of the waveguide.

The present invention also covers a method for manufacturing a module forming the object of the present description.

The entire module 1 is preferably produced as a single piece, by additive manufacturing. It is also possible to produce the entire module 1 from several units assembled to each other, each unit comprising the four layers 3, 4, 5, 6, or at least the first layer 3, the second layer 4 and the fourth layer 6. Manufacturing by subtractive machining or by assembling is also possible, as is a combination of additive manufacturing and subtractive machining steps. The phase-adjustment elements 500 are preferably produced by an additive manufacturing method.

In one embodiment, the module is produced entirely from metal, for example aluminum, by additive manufacturing.

In another embodiment, the module 1 comprises a core made from polymer, PEEK, metal or ceramic, and a conductive coating deposited on the faces of this core.

The core of the module 1 may be formed from a polymer material, ceramic, a metal or an alloy, for example from aluminum, titanium or steel. The phase-adjustment elements 500 may be integrated into the core and formed from the same material as the core. The conductive coating may cover the phase-adjustment elements 500.

The core of the module 1 may be produced by stereolithography or by selective laser melting. The core may comprise different parts that are assembled together, for example by gluing or welding. In this case, the phase-adjustment elements 500 may be added to the core and associated with the core by gluing or welding.

The metal layer forming the coating may comprise a metal chosen from Cu, Au, Ag, Ni, Al, stainless steel, brass or a combination of these metals.

One or more of the inner and outer surfaces of the core, including the phase-adjustment elements 500, may be covered with a conductive metal layer, for example copper, silver, gold, nickel etc., plated by electroless deposition. The thickness of this layer is, for example, between 1 and 20 micrometers, for example between 4 and 10 micrometers.

The thickness of this conductive covering must be sufficient for the surface to be electrically conductive at the chosen radio frequency. This is typically achieved using a conductive layer with a thickness greater than the depth of skin 8.

This thickness is preferably substantially constant over all of the inner surfaces in order to obtain a finished part that has precise dimensional tolerances.

The conductive metal can be deposited on the inner and possibly outer faces by submerging the core in a series of successive baths, typically between 1 and 15 baths. Each bath involves a fluid with one or more reagents. The deposition does not require current to be applied to the core that is to be covered. Stirring and even deposition are achieved by moving the fluid, for example by pumping the fluid through the transmission channel and/or around the module 1 or by vibrating the core and/or the tank of fluid, for example with an ultrasonic vibrating device, to create ultrasonic waves.

The conductive metal coating may cover all of the faces of the core in an uninterrupted manner. In another embodiment, the module 1 comprises side walls with outer and inner surfaces, the inner surfaces delimiting a channel, said conductive coating covering said inner surface but not all of the outer surface.

The module 1 may comprise a smoothing layer intended to at least partially smooth irregularities on the surface of the core. The conductive coating is deposited over the smoothing layer.

The module 1 may comprise a primer (or adhesion) layer deposited on the core so as to cover it in an uninterrupted manner.

The primer layer may be made from conductive or non-conductive material. The primer layer helps improve the adhesion of the conductive layer to the core. Its thickness is preferably less than the roughness Ra of the core, and less than the resolution of the method of additive manufacturing used to manufacture the core.

In one embodiment, the module 1 successively comprises a non-conductive core produced by additive manufacturing, including one or more phase-adjustment elements 500, a primer layer, a smoothing layer and a conductive layer. Therefore, the primer layer and the smoothing layer help reduce the roughness of the surface of the waveguide channel. The primer layer helps improve the adhesion of the conductive or non-conductive core with the smoothing layer and the conductive layer.

The shape of the module 1 may be determined by a computer file stored on a data storage medium and used to control an additive manufacturing device.

Furthermore, the shape, number, location, dimensions and any other useful parameter relating to the phase-adjustment elements 500 may be determined by a computer file stored on a data storage medium and used to control an additive manufacturing device.

Alternatively, or additionally, the shape, number, location, dimensions and any other useful parameter relating to the phase-adjustment elements 500 may be determined in full or in part by means of a modeling program. Such a program can be used, for example, to determine at least some of the characteristics of the phase-adjustment elements 500 that are needed in order to eliminate or modulate the phase shift, depending on the characteristics of the waveguides that are used. Such a modeling program may, for example, take into account the length of the waveguide in question, its longitudinal shape, including curves, the shape of its cross section, and any other useful parameter, as well as the wavelength of the signal. The modeling may include applying an algorithm for determining the phase shift of a waveguide depending on its characteristics. It may include applying an algorithm, for example an analytical or successive approximation algorithm, for determining one or more characteristics of the phase-adjustment elements 500 needed to correct, control or eliminate this phase shift. The characteristics of the phase-adjustment elements 500 include one or more of their dimensions, their shapes, how many of them there are, and their arrangement in the waveguide, including their orientation and location.

An artificial intelligence and/or deep learning module may be used to determine the effect of the phase-adjustment elements 500 on the phase shift and the transfer function of the waveguides. When the characteristics of the phase-adjustment elements are determined, they may be transferred to an additive manufacturing device in order to produce them.

The module may be connected to an electronic circuit, for example in the form of a printed circuit mounted behind the third layer 5 of ports or behind the fourth layer 6, with amplifiers and/or phase shifters connected to each port.

1. A radiofrequency module, comprising:
a first layer comprising an array of radiating elements, each radiating element having a cross section supporting at least one wave propagation mode; and
a second layer forming an array of waveguides, each waveguide being connected to one radiating element of the first layer, the waveguides being of different lengths,
wherein one or more of the waveguides of the array of waveguides comprises at least one phase-adjustment element designed to eliminate or correct the phase shift of the waveguides with respect to each other at a nominal frequency of the waveguide without modifying their space requirement or the shape or dimensions of their cross section.

2. The module as claimed in claim 1, wherein the at least one phase-adjustment element is arranged protruding from the inner surface of said waveguides.

3. The radiofrequency module as claimed in claim 1, wherein said at least one phase-adjustment element is arranged on the inner surface of said waveguide in such a way as to vary the inner diameter between a maximum diameter value and a minimum diameter value over the length of the waveguide or a portion of its length.

4. The radiofrequency module as claimed in claim 1, wherein said one or more waveguides comprises more than one phase-adjustment element, arranged on the same section of the waveguide or offset along the waveguide.

5. The radiofrequency module as claimed in claim 1, wherein said at least one phase-adjustment element is oriented along an axis different from the longitudinal axis of the corresponding waveguide, forming an angle of between approximately 10° and 40° with the longitudinal axis.

6. The radiofrequency module as claimed in claim 1, wherein the shape of a transverse section of said at least one phase-adjustment element is selected from a rounded concave shape, a rounded convex shape, a polygonal shape, or a combination of these shapes.

7. The radiofrequency module as claimed in claim 1, wherein the proportion of the inner surface occupied by one or more phase-adjustment elements may vary from 10% to 100%, preferably from 20% to 100%, for a given transverse section of the waveguide.

8. The radiofrequency module as claimed in claim 1, wherein the waveguides of the array of waveguides comprise longitudinal inner structures that do not allow the phase shift to be eliminated or controlled, the phase shifts produced by the array of waveguides being eliminated or corrected, at least partially, for some or each of the waveguides, by means of said phase-adjustment elements.

9. The radiofrequency module as claimed in claim 1, wherein the different waveguides have different lengths and/or different curvatures and identical or different transverse sections, which remain incapable of eliminating or correcting differences in frequency response and/or phase differences caused by the different lengths and/or different curvatures of the waveguides, the phase shifts produced by the array of waveguides being eliminated or corrected, at least partially, for some or each of the waveguides, by means of said phase-adjustment elements.

10. The radiofrequency module as claimed in claim 1, wherein the different waveguides have a constant and/or identical transverse section.

11. The radiofrequency module as claimed in claim 1, wherein said waveguides comprise a core, said at least one phase-adjustment element being directly linked to or integrated into the core.

12. The radiofrequency module as claimed in claim 11, wherein the surfaces of the core and said at least one phase-adjustment element are covered with a conductive material.

13. The radiofrequency module as claimed in claim 1, wherein some of the waveguides are non-straight, such that the second layer is flared.

14. The radiofrequency module as claimed in claim 1, wherein the curvature of the different waveguides of the second layer varies within the module.

15. The radiofrequency module as claimed in claim 1, comprising a fourth layer with ports connected to the waveguides at the end of the waveguides opposite the radiating elements,
the surface area of the first layer being smaller than the surface area of the fourth layer in such a way that the waveguides move towards each other between the fourth layer and the first layer, or indeed the surface area of the first layer being larger than the surface area of the fourth layer in such a way that the waveguides move away from each other between the fourth layer and the first layer.

16. The radiofrequency module as claimed in claim 1, wherein said phase-adjustment elements make it possible to eliminate the phase shifts of the waveguides, so that all of the waveguides are isophasic at the wavelength in question.

17. The radiofrequency module as claimed in claim 1, wherein said phase-adjustment elements make it possible to correct the phase shifts of the waveguides, so as to produce a controlled phase shift.

18. The radiofrequency module as claimed in claim 1, wherein said at least one phase-adjustment element is non-symmetrical and/or arranged in the waveguide in an irregular manner at different intervals.

19. The radiofrequency module as claimed in claim 1, wherein said at least one phase-adjustment element makes it possible to use the phase shifts in the absence of an array of active electronic phase shifting circuits, in order to control the relative phase shift between radiating elements and, for example, to control beamforming.

20. The radiofrequency module as claimed in claim 1, wherein the pitch between two radiating elements of the first layer is less than λ\2, λ being the wavelength at the maximum operating frequency.

21. The radiofrequency module as claimed in claim 1, wherein the pitch between two radiating elements varies within the module.

22. The radiofrequency module as claimed in claim 1, wherein the radiating elements of the first layer are non-ridged and constituted by open waveguides with a square, rectangular, circular, hexagonal or octagonal cross section, or pyramid-shaped or spline-shaped horns.

23. The radiofrequency module as claimed in claim 15, comprising a third layer interposed between the second layer and the fourth layer and comprising an array of elements providing cross-section adaptation between the cross section of the output of the ports of the fourth layer and the differently shaped cross section of the waveguides.

24. The radiofrequency module as claimed in claim 15, comprising a third layer interposed between the second layer and the fourth layer and comprising an array of elements comprising a polarizer.

25. The radiofrequency module as claimed in claim 1, comprising polarizers between the first and second layers.

26. The radiofrequency module as claimed in claim 15, comprising a third layer interposed between the second layer and the fourth layer and comprising a filter.

27. The radiofrequency module as claimed in claim 1, wherein each waveguide has a square, de rectangular, hexagonal, round or oval transverse section.

28. The radiofrequency module as claimed in claim 1, wherein each waveguide is designed to transmit either only a fundamental mode or a fundamental mode and a single degenerate mode.

29. The radiofrequency module as claimed in claim 1, wherein a first end of all of the waveguides lies in a first plane, a second end of all of the waveguides lying in a second plane.

30. The radiofrequency module as claimed in claim 1, wherein has been produced by additive manufacturing.

31. The radiofrequency module as claimed in claim 1, wherein the assembly of waveguides forms a single-piece component.

32. A method for producing a radiofrequency module as claimed in claim 1, comprising modeling at least some of the characteristics of said at least one phase-adjustment element by means of one or more algorithms, said characteristics being selected from the number, dimensions, arrangement and shape of the phase-adjustment elements.

33. The production method as claimed in claim 32, wherein the modeling involves an artificial intelligence or deep learning module.

34. The production method as claimed in claim 32, comprising transferring at least some of the parameters from the modeling to an additive manufacturing device.
